(19) United States
(12) Patent Application Publication
(10) Pub. No.: US 2011/0250379 A1
(43) Pub. Date: Oct. 13, 2011

(54) CROSS-GRAINED LAMINATIONS OF EXTRUDED PLASTICS FOR CONSTRUCTING ORAL PROSTHETICS AND METHOD OF MANUFACTURING CROSS-GRAINED LAMINATIONS OF EXTRUDED PLASTICS

(76) Inventor: DONALD M. NEVIN, (US)

(21) Appl. No.: 12/952,274

(22) Filed: Nov. 23, 2010

Related U.S. Application Data
(60) Provisional application No. 61/342,113, filed on Apr. 12, 2010.
(60) Provisional application No. 61/399,523, filed on Jul. 14, 2010.

(51) Int. Cl. A61C 5/14; B29C 65/00; B32B 5/12; A61C 13/08; A61C 7/08; B29C 65/02; B29C 65/10

(52) U.S. Cl. 428/105; 156/308.2; 156/285

(57) ABSTRACT

A method for manufacturing a laminate for making a dental prosthetic is provided. The method includes arranging a first plastic sheet with a first grain orientation on a second plastic sheet with a second grain orientation. The first grain orientation and the second grain orientation form an angle greater than 0 degrees and less than 180 degrees. The method also includes fusing the first plastic sheet and the second plastic sheet together. The angle may be approximately 90 degrees. A dental prosthetic laminate is provided that includes a first plastic sheet having a first grain orientation, and a second plastic sheet having a second grain orientation fused together with the first plastic sheet. The second grain orientation forms an angle with the first grain orientation, the angle being greater than 0 degrees and less than 180 degrees. A method for manufacturing a dental prosthetic form is provided.

### CROSS-REFERENCE TO RELATED APPLICATIONS

This application claims the benefit of U.S. Provisional Application No. 61/342,113 filed Apr. 12, 2010, and this application also claims the benefit of U.S. Provisional Application No. 61/399,523 filed Jul. 14, 2010, both of which are incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to oral prosthetics, and in a particular relates to cross-grain laminates used to increase the strength and workability of oral prosthetics.

2. Description of Prior Art

Mouth guards may be used in sports such as football, soccer, hockey, boxing, and others to protect the teeth of the athlete from impacts that contact sports generate. Such mouth guards are also helpful in preventing concussion. Mouth guards may be mandatory in some states even for “non-contact sports” such as basketball, soccer, and wrestling.

Dental mouth guards have been fabricated from several different plastic materials, and may be manufactured from ethylene vinyl acetate (EVA), urethanes, polycarbonates and other plastics which may have the properties of low toxicity and impact resistance. Dental mouth guards and other oral prosthetics have been made from extruded or injection molded plastic sheets which are heated in a dentist's laboratory or in a commercial dental laboratory and vacuum or pressure formed over a “stone” model of the patient's dentition.

Other prostheses and dental retainers are fabricated from the same or different materials using similar vacuum or pressure forming techniques.

### BRIEF SUMMARY OF THE INVENTION

A method for manufacturing a laminate for making a dental prosthetic is provided. The method includes arranging a first plastic sheet with a first grain orientation on a second plastic sheet with a second grain orientation. The first grain orientation and the second grain orientation form an angle greater than 0 degrees and less than 180 degrees. The method also includes fusing the first plastic sheet and the second plastic sheet c.

The fusing operation may include heating the first plastic sheet and the second plastic sheet to between 50 and 80 percent of a lowest melting point of the first plastic sheet and the second plastic sheet, or possibly between 50 and 70 percent of the lowest melting point, or possibly between 50 and 65 percent of the lowest melting point.

The fusing operation may include evacuating air from around the first plastic sheet and the second plastic sheet, and may include applying pressure to sandwich the first plastic sheet and the second plastic sheet.

The first plastic sheet and the second plastic sheet may include ethylene vinyl acetate (EVA), urethane, a polycarbonate or any other appropriate material.

The method may include labeling the laminate to indicate at least one of the first grain and the second grain.

The dental prosthetic made by the laminate may include a dental mouth guard, a dental splint, a retainer and/or another oral prosthetic.

The method may include arranging a third plastic sheet with a third grain orientation on the first plastic sheet or the second plastic sheet. The third grain orientation may form a second angle with the one of the first grain orientation and the second grain orientation corresponding to the first plastic sheet or the second plastic sheet. The second angle may be greater than 0 degrees and less than 180 degrees. The fusing operation may further include fusing the third plastic sheet with the first plastic sheet and/or the second plastic sheet.

The fusing of the third plastic sheet with the first plastic sheet and/or the second plastic sheet may occur at a same time, or at a different time, as the fusing of the first plastic sheet and the second plastic sheet. The angle may be approximately 90 degrees.

A dental prosthetic laminate is provided that includes a first plastic sheet having a first grain orientation, and a second plastic sheet having a second grain orientation fused to the first plastic sheet. The second grain orientation forms an angle with the first grain orientation. The angle is greater than 0 degrees and less than 180 degrees.

The dental prosthetic laminate may include a label on the first plastic sheet or the second plastic sheet indicating the first grain orientation and/or the second grain orientation.

The dental prosthetic laminate may further include a third plastic sheet with a third grain orientation on the first plastic sheet or the second plastic sheet. The third grain orientation may form a second angle with the first grain orientation or the second grain orientation corresponding to the first plastic sheet or the second plastic sheet. The second angle may be greater than 0 degrees and less than 180 degrees. The third plastic sheet may be fused with the first plastic sheet or the second plastic sheet.

A method for manufacturing a dental prosthetic form is provided that includes arranging a first plastic sheet with a first grain orientation on a second plastic sheet with a second grain orientation forming an angle between the first grain orientation and the second grain orientation. The angle is greater than 0 degrees and less than 180 degrees. The method also includes fusing the first plastic sheet and the second plastic sheet together to form a laminate, and forming the laminate into the dental prosthetic.

### BRIEF DESCRIPTION OF THE DRAWINGS

FIG. 1 is a perspective view of an exemplary first plastic sheet having a first grain orientation;

FIG. 2 is a perspective view of an exemplary second plastic sheet having a second grain orientation;

FIG. 3 is a perspective view of an exemplary fusion of the first and second plastic sheets from FIGS. 1 and 2 having a cross-grain; and

FIG. 4 is a flow chart illustrating an exemplary method.

### DETAILED DESCRIPTION OF THE INVENTION

In the following description, dental prosthetics refers to dental mouth guards, splints, retainers or any other oral prosthetic. Additionally, any description of mouth guards in the following may also apply to other dental or oral prosthetics.

Laminated versions of dental prosthetics have been used, and laminates may provide superior impact resistance. Exemplary embodiments of the instant invention provide for oral prosthetics constructed from cross-grained laminations of extruded plastics.

Mouth guards may be fabricated from ethyl vinyl acetate (EVA). Some mouth guards consist of a single sheet or multiple laminated sheets which are formed over a model of a patient's dentition, and some are pre-formed. Urethane mouth guards may be processed in a similar manner. The urethane polymer may be extruded into a sheet, injection molded into a sheet, or pre-formed.

Mouth guards may be 0.150 inches (approx. 3.8 mm) or 0.160 inches (approx. 4 mm) in thickness. Mouth guards may be single-ply extrusions, or may be injection molded. Mouth guards may also be laminates of two or more layers. The layers may be composed of different materials when the varying properties are considered advantageous for a particular use or a particular patient.

A multi-laminated mouthguard may be fabricated using heat and vacuum pressure. EVA dental plastic may be formed with positive pressure at about 90 psi, or at 12 psi for vacuum pressure. A multi-laminated mouthguard with an interoclussal (i.e., the vertical distance between the occluding surfaces of the upper and lower teeth when the mandible is in the resting position) thickness of between 3 to 5 millimeters may reduce a rate of concussion received by a blow to the mandible. Vacuum-forming a single sheet of EVA may cause the material to lose approximately 50 percent of its original thickness as it softens and droops.

An EVA-based co-polymer may provide high shock-absorption and be laminated to itself using vacuum pressure. Laminating may be performed in different forming cycles. An exemplary method according to the present innovation may allow fabrication of a mouthguard with increased thickness using a vacuum-form machine, which typically costs less than pressure laminating machines. To determine the final thickness of a multi-layer mouthguard, a rule of thumb may be to calculate the thinning of the material in processing at 50 percent. For instance, to fabricate a mouthguard with a final thickness of 3 to 3.5 millimeters, a total of two layers that have a combined thickness equaling 6 or more millimeters may be used. In particular, a first layer of 3-millimeter sheet followed by another 3-millimeter sheet may be used, or a first layer of 4 millimeter followed by a 2-millimeter sheet may be used.

In an exemplary embodiment of the present invention, the plastic sheets are oriented prior to lamination so that the grains of the several sheets are at right angles, or alternatively, at another specified angle other than 0 degrees. The cross-grain structure may increase impact strength and may allow for thinner appliances which may be more comfortable for the user. An exemplary embodiment of the present invention provides for laminating two or more layers, the grain of which are at a 90 degree angle to a layer below and/or above. This structure provides the unexpected benefit of imparting additional strength to the finished product. This is called an orthotropic orientation.

While there may be no general grain in injection molded sheets, there typically is a grain in an extruded product. The grain may be difficult to see so it may be beneficial that a dentist or dental technician using this invention either have an indicator on each sheet or purchase a prelaminated product in which the manufacturer has exercised control to make sure the grain angle and orientation are correct. In addition, exemplary embodiments provide that single sheets, which may be intended to be laminated in the dental office or dental lab, may include a directional indicator of the grain which will allow the lab technician to identify the sheet orientation.

An unexpected benefit is that the orthotropic material resists the tendency to become thin when vacuum-formed over a stone model. Normal mouth guard materials and laminates tend to thin out in areas where the material is stretched. In particular the grinding surfaces of teeth, areas of high vertical gradient, the occlusal surfaces and the palatal areas may be thinner than the balance of the mouth guard. Experiments have shown minimal thinning of orthotropic material. For example, when using a material in an exemplary embodiment having a thickness of 0.160 inches prior to forming, most of the mouth guard retains a thickness of at least 0.145 inches after forming. The orthotropic material may stabilize the internal stresses that normally cause the material to thin during the heating and/or vacuum or pressure forming process.

An orthotropic mouth guard made according to the present application may provide the additional unexpected benefit of producing little or no smoke in the process of vacuum or pressure forming. This contrasts with medium to large amounts of smoke generated when forming conventional mouth guard materials.

In exemplary embodiments, laminate sheets may be formed to make a “jigsaw” pattern such that the sheets may have differing grain angles at various points in order to achieve beneficial results, and/or different strengths or deformability in specific directions, and/or in response to specific stressors.

An exemplary method for manufacturing the orthotropic materials may include the following steps. First, materials are “laid” up in a cross-grained orientation and “release paper” is placed between layers which are not to be bonded. The release paper may contain a slightly raised design to give a particular look (e.g., sandstone) and/or a grain direction indicator. The sheets are stacked and surrounded by a vacuum bag and placed in an industrial autoclave, for example the Econoclave (made by ASC Process Systems of Sylmar, Calif.). A layer of glass is placed on top of the stacks to evenly distribute pressure.

Second, the bag is evacuated and heat is applied. The temperature may preferably be 50-80%, more preferably 50-70% and most preferably 50-65%, of the lowest melting point of any of the components.

Third, the pressure in the chamber is increased to about 100 Lbs/sq. in. for a defined period of time depending on the materials used. In some cases, this time period may be approximately 1 hour.

Fourth, the temperature and pressure are reduced and the autoclave is brought down to standard temperature and pressure (STP) and opened. The bag is opened and the orthotropic laminates are removed.

In alternative exemplary embodiments, a third (or more) sheet of EVA may be fused or laminated in a separate processing cycle over the first layer. Alternatively, the third or more layer may be fused simultaneously with the first and second layers.

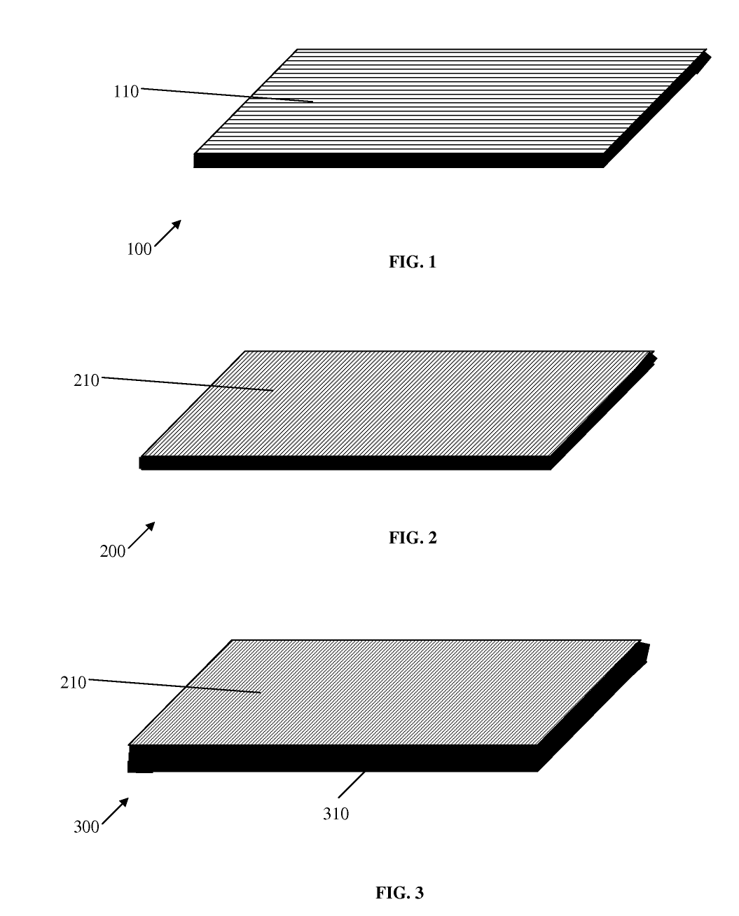

FIG. 1 is a perspective view of first laminate sheet 100. First laminate sheet 100 may have first grain orientation 110 in a first direction. First grain orientation 110 may be a direct result of the extruding process, and may correspond to the direction in which the plastic sheet is extruded.

FIG. 2 is a perspective view of second laminate sheet 200. Second laminate sheet 200 may have second grain orientation 210 in a second direction.

FIG. 3 is a perspective view of fused laminate sheet 300, which is a fusion of first laminate sheet 100 and second laminate sheet 200. First laminate sheet 100 may be fused with second laminate sheet 200 by heat and/or pressure, as discussed above. Prior to fusing, first laminate sheet 100 and second laminate sheet 200 may be oriented with respect to each other so that first grain orientation 110 and second grain orientation 210 are orthogonal. This orientation results in fused laminate sheet 300 having a cross-grain orientation. In FIG. 3, fused laminate sheet 300 displays second grain orientation 210 on top. On the bottom of fused laminate sheet 300, first grain orientation 110 would be displayed. Fusion line 310 of fused laminate sheet 300 is at a midpoint of a thickness of fused laminate sheet 300. Alternatively, if first laminate sheet 100 and second laminate sheet 200 have different thicknesses, fusion line 310 may be positioned closer to one surface than the other. At fusion line 310, the first laminate sheet 100 and second laminate sheet 200 are fused and first grain orientation 110 and second grain orientation 210 form the cross-grain orientation of fused laminate sheet 300.

Alternatively, rather than being orthogonal, first grain 110 and second grain 210 may be oriented at another angle between zero and 180 degrees.

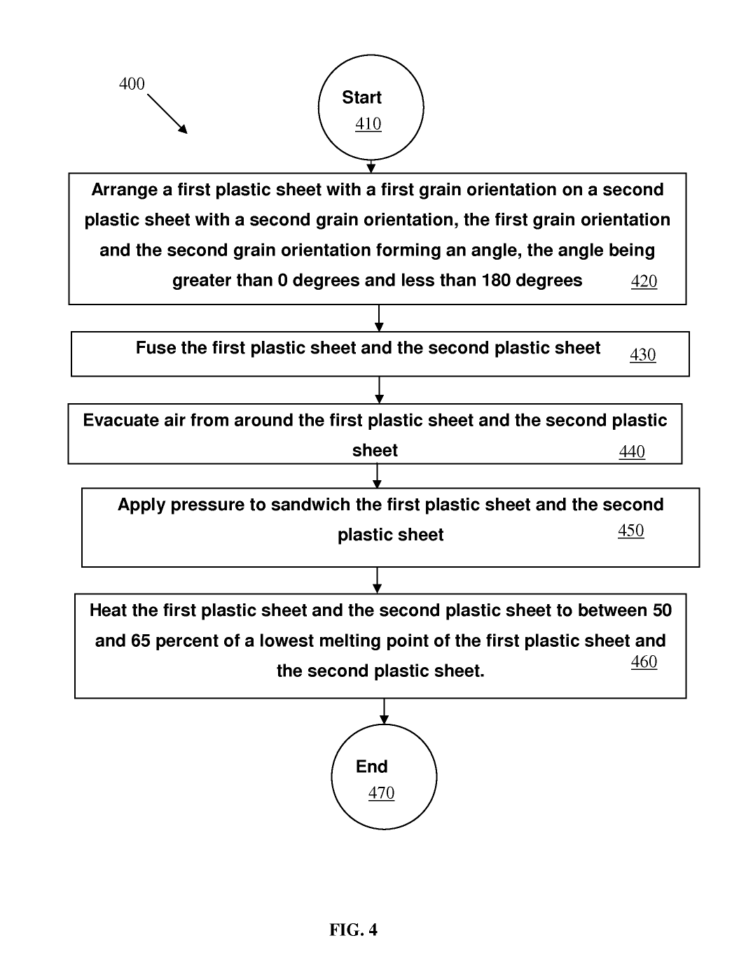

FIG. 4 illustrates method 400 according to an exemplary embodiment. Method 400 starts at start circle 410 and proceeds to operation 420, which indicates to arrange a first plastic sheet with a first grain orientation on a second plastic sheet with a second grain orientation. The first grain orientation and the second grain orientation form an angle greater than 0 degrees and less than 180 degrees. From operation 420 the flow in method 400 proceeds to operation 430, which indicates to fuse the first plastic sheet and the second plastic sheet. From operation 430 the flow in method 400 proceeds to operation 440, which indicates to evacuate air from around the first plastic sheet and the second plastic sheet. From operation 440 the flow in method 400 proceeds to operation 450, which indicates to apply pressure to sandwich the first plastic sheet and the second plastic sheet. From operation 450 the flow in method 400 proceeds to operation 460, which indicates to heat the first plastic sheet and the second plastic sheet to between 50 and 65 percent of a lowest melting point of the first plastic sheet and the second plastic sheet. From operation 460 the flow in method 400 proceeds to end circle 470. Some of the operations of method 400 may not be necessary to fuse the plastic sheets into a cross-grain structure, and may therefore be omitted.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A method for manufacturing a laminate for making a dental prosthetic, comprising:
arranging a first plastic sheet with a first grain orientation on a second plastic sheet with a second grain orientation, the first grain orientation and the second grain orientation forming an angle, the angle being greater than 0 degrees and less than 180 degrees; and
fusing the first plastic sheet and the second plastic sheet together.

2. The method of claim 1, wherein the fusing operation comprises heating the first plastic sheet and the second plastic sheet to between 50 and 80 percent of a lowest melting point of the first plastic sheet and the second plastic sheet.

3. The method of claim 2, wherein the fusing operation comprises heating the first plastic sheet and the second plastic sheet to between 50 and 70 percent of the lowest melting point.

4. The method of claim 2, wherein the fusing operation comprises heating the first plastic sheet and the second plastic sheet to between 50 and 65 percent of the lowest melting point.

5. The method of claim 1, wherein the fusing operation comprises evacuating air from around the first plastic sheet and the second plastic sheet.

6. The method of claim 1, wherein the fusing operation comprises applying pressure to sandwich the first plastic sheet and the second plastic sheet.

7. The method of claim 1, wherein the first plastic sheet and the second plastic sheet comprise one of ethylene vinyl acetate (EVA), urethane, and a polycarbonate.

8. The method of claim 1, further comprising labeling the laminate to indicate at least one of the first grain and the second grain.

9. The method of claim 1, wherein the dental prosthetic made by the laminate comprises at least one of a dental mouth guard, a dental splint, a retainer and another oral prosthetic.

10. The method of claim 1, further comprising:
arranging a third plastic sheet with a third grain orientation on one of the first plastic sheet and the second plastic sheet, the third grain orientation forming a second angle with the one of the first grain orientation and the second grain orientation corresponding to the one of the first plastic sheet and the second plastic sheet, the second angle being greater than 0 degrees and less than 180 degrees;
wherein the fusing operation further comprises fusing the third plastic sheet together with the first plastic sheet and the second plastic sheet.

11. The method of claim 10, wherein the fusing of the third plastic sheet with the first plastic sheet and the second plastic sheet occurs at a same time as the fusing of the first plastic sheet and the second plastic sheet.

12. The method of claim 1, wherein the angle is approximately 90 degrees.

13. A dental prosthetic laminate, comprising:
a first plastic sheet having a first grain orientation; and
a second plastic sheet having a second grain orientation fused together with the first plastic sheet, the second grain orientation forming an angle with the first grain orientation, the angle being greater than 0 degrees and less than 180 degrees.

14. The dental prosthetic laminate of claim 13, wherein the first plastic sheet and the second plastic sheet comprise one of ethylene vinyl acetate (EVA), urethane, and a polycarbonate.

15. The dental prosthetic laminate of claim 13, wherein the dental prosthetic laminate is adapted to be formed into a shape of a dental prosthetic.

16. The dental prosthetic laminate of claim 15, wherein the dental prosthetic comprises at least one of a dental mouth guard, a dental splint, a retainer and another oral prosthetic.

17. The dental prosthetic laminate of claim 13, further comprising a label on one of the first plastic sheet and the second plastic sheet indicating at least one of the first grain orientation and the second grain orientation.

18. The dental prosthetic laminate of claim 13, further comprising:
a third plastic sheet with a third grain orientation on one of the first plastic sheet and the second plastic sheet, the third grain orientation forming a second angle with the one of the first grain orientation and the second grain orientation corresponding to the one of the first plastic sheet and the second plastic sheet, the second angle being greater than 0 degrees and less than 180 degrees, the third plastic sheet being fused together with the one of the first plastic sheet and the second plastic sheet.

19. The dental prosthetic laminate of claim 13, wherein the angle is approximately 90 degrees.

20. A method for manufacturing a dental prosthetic form, comprising:
arranging a first plastic sheet with a first grain orientation on a second plastic sheet with a second grain orientation forming an angle between the first grain orientation and the second grain orientation, the angle being greater than 0 degrees and less than 180 degrees;
fusing the first plastic sheet together with the second plastic sheet to form a laminate; and
forming the laminate into the dental prosthetic.
